(19) United States
(12) Patent Application Publication
(10) Pub. No.: US 2010/0119834 A1
(43) Pub. Date: May 13, 2010

(54) COLOR-PLUS-CLEAR COMPOSITE COATINGS

(75) Inventors: Shanti Swarup, Allison Park, PA (US); Richard J. Sadvary, Pittsburgh, PA (US); Dennis A. Simpson, Sarver, PA (US)

Correspondence Address: Carol Marmo;PPG Industries, Inc., One PPG Place, Pittsburgh, PA, 15272, US

(73) Assignee: PPG Industries Ohio, Inc., Cleveland, OH (US)

(21) Appl. No.: 12/688,937

(22) Filed: Jan. 18, 2010

Related U.S. Application Data
(62) Division of application No. 11/608,423, filed on Dec. 8, 2006.

(51) Int. Cl. B32B 27/38; C08F 224/00; C08F 226/06; B32B 27/08

(52) U.S. Cl. 428/413; 525/327.3; 525/326.7

(57) ABSTRACT

A multi-component composite coating composition comprising an aqueous-based film-forming composition serving as a color coat or a basecoat and a polyepoxide-polyacid clearcoat is disclosed. The polyacid is made from ring opening a polybasic anhydride with a polyester polyol formed from reacting a polyol with a polycarboxylic acid having at least 20 contiguous carbon atoms between the carboxylic acid groups.

### FIELD OF THE INVENTION

The present invention relates to color-plus-clear composite coatings and more particularly to composite coatings based on epoxy-acid clearcoats and waterborne base or color coats.

### BACKGROUND OF THE INVENTION

Color-plus-clear coating systems involving the application of the colored or pigmented basecoat to a substrate followed by the application of a transparent or clear topcoat to the basecoat are becoming increasingly popular as original finishes for automobiles. The color-plus-clear systems have outstanding gloss and distinctness of image, and the clear topcoat is particularly important for these properties.

U.S. Pat. No. 4,650,718 discloses clearcoats based on polyepoxides and polyacid curing agent. While such clearcoats provide excellent physical properties such as resistance to acid etching, improvements in humidity, mar and scratch resistance would be desirable. Also, improved appearance over waterborne basecoats would be desirable.

### SUMMARY OF THE INVENTION

Disclosed is a multi-component composite coating composition comprising a pigmented film-forming composition serving as a basecoat and a clear film-forming composition serving as a transparent topcoat over the basecoat wherein
(a) the basecoat is deposited from an aqueous-based pigmented film-forming composition, and
(b) the transparent topcoat is deposited from a film-forming composition comprising:
   (i) a polyepoxide, and
   (ii) a polyacid curing agent formed by ring opening of a polybasic acid anhydride with hydroxyl groups of a polyester prepared by reacting a polybasic acid with an excess of a polyol in which the polybasic acid has a hydrocarbon chain containing at least 20 contiguous carbon atoms between the acid groups.

### DETAILED DESCRIPTION OF THE INVENTION

As used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to include the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. Further, as used herein, terms such as “deposited over”, “applied over”, or “provided over” mean deposited or provided on but not necessarily in contact with the surface. For example, a coating composition “deposited over” a substrate does not preclude the presence of one or more other coating films of the same or different composition located between the deposited coating and the substrate. Molecular weight quantities used herein, whether Mn or Mw, are those determinable from gel permeation chromatography using polystyrene as a standard. Also, as used herein, the term “polymer” includes oligomers, homopolymers, and copolymers.

The basecoat is deposited from an aqueous-based pigmented film-forming composition. The aqueous-based film-forming composition of the present invention can be any of the waterborne compositions useful as basecoats in automotive applications. Typically, such compositions comprise polymers with reactive functional groups such as hydroxyl and carboxylic acid and curing agents containing functional groups reactive with the functional groups of the polymer, for example, aminoplast.

Useful film-forming polymers containing functional groups (also referred to as crosslinkable film-forming resins) include acrylic polymers and copolymers, polyesters, polyurethanes, polyethers and mixtures thereof. These polymers can be self-crosslinking or crosslinked by reaction with suitable crosslinking materials included in the coating composition.

Suitable acrylic polymers and copolymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, such as 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride; and vinyl esters such as vinyl acetate.

The acrylic copolymer can include hydroxyl functional groups that are often incorporated into the polymer by including one or more hydroxyl functional monomers in the reactants used to produce the copolymer. Useful hydroxyl functional monomers include hydroxyalkyl acrylates and methacrylates, preferably having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates. The acrylic polymer can be prepared with N-(alkoxymethyl)acrylamides and N-(alkoxymethyl)methacrylamides that result in self-crosslinking acrylic polymers.

Acrylic polymers can be prepared via aqueous emulsion polymerization techniques and used directly in the preparation of the aqueous coating composition, or via organic solution polymerization techniques with groups capable of salt formation such as acid or amine groups. Upon neutralization of these groups with a base or acid, the polymers can be dispersed into aqueous medium. Generally, suitable crosslinkable film-forming resins have a weight average molecular weight greater than 2000 grams per mole, such as ranging from 2000 to 100,000 grams per mole (as determined by gel permeation chromatography using a polystyrene standard), and a hydroxyl equivalent weight ranging from 400 to 4000 grams per equivalent. The term “equivalent weight” is a calculated value based on the relative amounts of the various ingredients used in making the specified material and is based on the solids of the specified material. The relative amounts are those that result in the theoretical weight in grams of the material, such as a polymer produced from the ingredients, and give a theoretical number of the particular functional group that is present in the resulting polymer. The theoretical polymer weight is divided by the theoretical number to give the equivalent weight. For example, hydroxyl equivalent weight is based on the equivalents of reactive pendant and/or terminal hydroxyl groups in the hydroxyl-containing polymer.

Besides acrylic polymers, the resinous binder for the basecoat composition may be a polyester. Such polymers may be prepared in a known manner by condensation of polyhydric alcohols and polycarboxylic acids. Suitable polyhydric alcohols include ethylene glycol, propylene glycol, butylene glycol, 1,6-hexylene glycol, neopentyl glycol, diethylene glycol, glycerol, trimethylolpropane, pentaerythritol and dimethylol propionic acid.

Suitable polycarboxylic acids include succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the polycarboxylic acids such as anhydrides where they exist or lower alkyl esters of the polycarboxylic acids such as the methyl esters may be used. Typically, an excess of acid or an acid functional polyol such as dimethylol propionic acid are used in the polyester synthesis. The acid functionality can be at least partially neutralized with a base such as organic amine to dissolve or disperse the polyester in water.

Polyurethanes can also be used as the resinous binder of the basecoat. Among the polyurethanes that can be used are those formed from reacting polyols including polymeric polyols such as polyester polyols or acrylic polyols such as those mentioned above with a polyisocyanate such that the OH/NCO equivalent ratio is greater than 1:1 so that free hydroxyl groups are present in the product. Also, the polyurethane preferably has free acid groups that can be at least partially neutralized with a base such as an organic amine to dissolve or disperse the polyurethane in water. An example of incorporating acid groups into the polyurethane is to use a mixed polyol such as a polymeric polyol and an acid functional polyol such as dimethylol propionic acid.

The organic polyisocyanate that is used to prepare the polyurethane polyol can be an aliphatic or an aromatic polyisocyanate or a mixture of the two. Diisocyanates are preferred, although higher polyisocyanates can be used in place of or in combination with diisocyanates.

Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis(cyclohexyl isocyanate). Examples of suitable higher polyisocyanates are 1,2,4-benzene triisocyanate and polymethylene polyphenyl isocyanate.

Water-based basecoats in color-plus-clear compositions are disclosed in U.S. Pat. No. 4,403,003, and the resinous compositions used in preparing these basecoats can be used in the practice of this invention. Also, water-based polyurethanes such as those prepared in accordance with U.S. Pat. No. 4,147,679 can be used as the resinous binder in the basecoat.

The crosslinkable film-forming resin can have an acid value ranging from 5 to 100 mg KOH/g resin, such as 20 to 100 mg KOH/g resin. The acid value (number of milligrams of KOH per gram of solid required to neutralize the acid functionality in the resin) is a measure of the amount of acid functionality in the resin.

Generally, the crosslinkable film-forming resin is present in an amount ranging from 40 to 94, such as 50 to 80 percent by weight on a basis of total weight of resin solids of the topcoat coating composition. The aqueous coating composition further comprises one or more curing agents or crosslinking materials capable of reacting with the crosslinkable film-forming resin to form a crosslinked film. The crosslinking material can be present as a mixture with the other components of the aqueous coating composition (conventionally referred to as a one-pack system), or in a separate composition which is mixed with the crosslinkable film-forming resin within a few hours prior to application of the coating composition to the substrate (conventionally referred to as a two-pack system).

Suitable crosslinking materials include aminoplasts and polyisocyanates, and mixtures thereof. Useful aminoplast resins are based on the addition products of formaldehyde with an amino- or amido-group carrying substance. Condensation products obtained from the reaction of alcohols and formaldehyde with melamine, urea or benzoguanamine are most common and preferred herein. While the aldehyde employed is most often formaldehyde, other similar condensation products can be made from other aldehydes, such as acetaldehyde, crotonaldehyde, acrolein, benzaldehyde, furfural, glyoxal and the like.

Condensation products of other amines and amides can also be used, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Non-limiting examples of such compounds include N,N′-dimethyl urea, benzourea, dicyandiamide, formaguanamine, acetoguanamine, glycoluril, ammeline, 3,5-diaminotriazole, triaminopyrimidine, 2-mercapto-4,6-diaminopyrimidine and carbamoyl triazines of the formula C₃N₃(NHCOXR)₃ where X is nitrogen, oxygen or carbon and R is a lower alkyl group having from one to twelve carbon atoms or mixtures of lower alkyl groups, such as methyl, ethyl, propyl, butyl, n-octyl and 2-ethylhexyl. Such compounds and their preparation are described in detail in U.S. Pat. No. 5,084,541.

The aminoplast resins preferably contain methylol or similar alkylol groups, and in most instances at least a portion of these alkylol groups are etherified by reaction with an alcohol. Any monohydric alcohol can be employed for this purpose, including methanol, ethanol, propanol, butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. The aminoplast resins typically are substantially alkylated with methanol or butanol.

The polyisocyanate that is utilized as a crosslinking agent can be prepared from a variety of isocyanate-containing materials. Preferably the polyisocyanate is a blocked polyisocyanate. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols also can be used. Examples of suitable blocking agents include those materials that would unblock at elevated temperatures such as lower aliphatic alcohols including methanol, oximes such as methyl ethyl ketoxime, lactams such as caprolactam and pyrazoles such as dimethylpyrazole.

Generally, the crosslinking material is present in an amount ranging from 5 to 50, such as 10 to 40 weight percent on a basis of total weight of resin solids of the aqueous coating composition.

The basecoat composition also contains pigments to give it color. Compositions containing metallic flake pigmentation are useful for the production of so-called “glamour metallic” finishes chiefly upon the surface of automobile bodies. Proper orientation of the metallic pigments results in a lustrous shiny appearance with excellent flop, distinctness of image and high gloss. By flop is meant the visual change in brightness or lightness of the metallic coating with a change in viewing angle, that is, a change from 90° to 180°. The greater the change, that is, from light to dark appearance, the better the flop. Flop is important because it accentuates the lines of a curved surface such as on an automobile body. Suitable metallic pigments include in particular aluminum flake, copper bronze flake and mica.

Besides the metallic pigments, the basecoat compositions of the present invention may contain non-metallic color pigments conventionally used in the surface coating compositions including inorganic pigments such as titanium dioxide, iron oxide, chromium oxide, lead chromate and carbon black, and organic pigments such as phthalocyanine blue and phthalocyanine green. In general, the pigment is incorporated into the coating composition in amounts of about 1 to 80 percent by weight based on weight of coating solids. The metallic pigment is employed in amounts of about 0.5 to 25 percent by weight of the aforesaid aggregate weight.

If desired, the basecoat composition may additionally contain other materials well known in the art of formulated surface coatings. These would include surfactants, flow control agents, thixotropic agents, fillers, anti-gassing agents, organic co-solvents, catalysts and other customary auxiliaries. These materials can constitute up to 40 percent by weight of the total weight of the coating composition.

The basecoat compositions as well as the subsequently applied clearcoat compositions can be applied to various substrates to which they adhere. The compositions can be applied by conventional means including brushing, dipping, flow coating, spraying and the like, but they are most often applied by spraying. The usual spray techniques and equipment for air spraying and electrostatic spraying, such as electrostatic bell application, and either manual or automatic methods can be used.

Examples of substrates over which the basecoats may be applied are metals, plastic, foam, including elastomeric substrates, and the like that are found on motor vehicles. The substrates typically contain a primer coat such as one applied by electrodeposition and optionally a primer surfacer applied by spraying.

After application to the substrate of the basecoat composition, a film is formed on the surface of the substrate. This is achieved by driving solvent, i.e., water and organic solvent, out of the basecoat film by heating or simply by an air-drying period. Preferably, the heating step will only be sufficient and for a short period of time to insure that the clearcoat composition can be applied to the basecoat without the former dissolving the basecoat composition, i.e., “striking in”. Suitable drying conditions will depend on the particular basecoat composition, on the ambient humidity with certain waterbased compositions, but in general a drying time of from about 1 to 5 minutes at a temperature of about 60°-200° F. (20°-93° C.) will be adequate to insure that mixing of the two coats is minimized. At the same time, the basecoat film is adequately wetted by the clearcoat composition so that satisfactory intercoat adhesion is obtained. Also, more than one basecoat and multiple clearcoats may be applied to develop the optimum appearance. Usually between coats, the previously applied basecoat or clearcoat is flashed, that is, exposed to ambient conditions for about 1 to 20 minutes.

Curing of both the basecoat and clearcoat is typically accomplished in one step by heating the composite coating to a temperature of 120 to 160° C., preferably 130 to 150° C. for 15 to 40 minutes. If desired, the basecoat can be first cured by heating at the above temperatures and times followed by application and subsequent curing of the clearcoat.

Typically, the basecoat has a dry film thickness of from 0.05 to 3, preferably 0.1 to 2 mils, and the clearcoat will have a dry film thickness of from 0.5 to 4.0 preferably 1.5 to 2.5 mils.

The transparent topcoat is deposited from a film-forming composition comprising a polyepoxide and a polyacid curing agent.

The polyepoxide typically has a high epoxy functionality (corresponds to low epoxide equivalent weight). More specifically, the polyepoxide of the present invention typically has an epoxide equivalent weight on resin solids of less than about 2000, and typically within the range of 150 to 1500.

The polyepoxide typically has a relatively low molecular weight. More specifically, the polyepoxide of the present invention can have a number average molecular weight of no more than about 20,000, more preferably within the range of 500 to 20,000.

Among the polyepoxides that can be used are epoxy-containing acrylic polymers, epoxy condensation polymers such as polyglycidyl ethers of alcohols and phenols, polyglycidyl esters of polycarboxylic acids, certain polyepoxide monomers and oligomers and mixtures of the foregoing.

The epoxy-containing acrylic polymer is a copolymer of an ethylenically unsaturated monomer having at least one epoxy group and at least one polymerizable ethylenically unsaturated monomer that is free of epoxy groups.

Examples of ethylenically unsaturated monomers containing epoxy groups are those containing 1,2-epoxy groups and include glycidyl acrylate, glycidyl methacrylate and allyl glycidyl ether.

Examples of ethylenically unsaturated monomers that do not contain epoxy groups are alkyl esters of acrylic and methacrylic acid containing from 1 to 20 atoms in the alkyl group. Specific examples of these acrylates and methacrylates include methyl methacrylate, ethyl methacrylate, butyl methacrylate, ethyl acrylate, butyl acrylate and 2-ethylhexyl acrylate. Examples of other copolymerizable ethylenically unsaturated monomers are vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The epoxy group-containing ethylenically unsaturated monomer is preferably used in amounts of from about 20 to 90, more preferably from 30 to 70 percent by weight of the total monomers used in preparing the epoxy-containing acrylic polymer. Of the remaining polymerizable ethylenically unsaturated monomers, preferably from 10 to 80 percent, more preferably from 30 to 70 percent by weight of the total monomers are the alkyl esters of acrylic and methacrylic acid.

The acrylic polymer may be prepared by solution polymerization techniques in the presence of suitable catalysts such as organic peroxides, such as t-butyl perbenzoate, t-amyl peracetate or ethyl-3,3-di(t-amylperoxy)butyrate or azo compounds, such as benzoyl peroxide, N,N′-azobis(isobutyronitrile) or alpha, alpha-dimethylazobis(isobutyronitrile). The polymerization can be carried out in an organic solution in which the monomers are soluble. Suitable solvents are aromatic solvents such as xylene and toluene, ketones such as methyl amyl ketone or ester solvents such as ethyl 3-ethoxypropionate. Alternately, the acrylic polymer may be prepared by aqueous emulsion or dispersion polymerization techniques.

The epoxy condensation polymers which are used are polyepoxides, that is, those having a 1,2-epoxy equivalency greater than 1, preferably greater than 1 and up to about 5.0. A useful example of such epoxides are polyglycidyl esters from the reaction of polycarboxylic acids with epihalohydrin such as epichlorohydrin. The polycarboxylic acid can be formed by any method known in the art and in particular, by the reaction of aliphatic alcohols with an anhydride, and in particular, diols and higher functionality alcohols. For example, trimethylol propane or pentaerythritol can be reacted with hexahydrophthalic anhydride to produce a polycarboxylic acid which is then reacted with epichlorohydrin to produce a polyglycidyl ester. Such compounds are particularly useful because they are low molecular weight. Accordingly, they have low viscosity and therefore, high solids coatings compositions can be prepared with them. Additionally, the polycarboxylic acid can be an acid-functional acrylic polymer.

Further examples of such epoxides are polyglycidyl ethers of polyhydric phenols and of aliphatic alcohols. These polyepoxides can be produced by etherification of the polyhydric phenol or aliphatic alcohol with an epihalohydrin such as epichlorohydrin in the presence of alkali.

Examples of suitable polyphenols are 2,2-bis(4-hydroxyphenyl)propane (bisphenol A) and 1,1-bis(4-hydroxyphenyl)ethane. Examples of suitable aliphatic alcohols are ethylene glycol, diethylene glycol, pentaerythritol, trimethylol propane, 1,2-propylene glycol and 1,4-butylene glycol. Also, cycloaliphatic polyols such as 1,2-cyclohexanediol, 1,4-cyclohexanediol, 1,4 cyclohexane dimethanol, 1,2-bis(hydroxymethyl)cyclohexane and hydrogenated bisphenol A can also be used.

Besides the epoxy-containing polymers described above, certain polyepoxide monomers and oligomers can also be used. Examples of these materials are described in U.S. Pat. No. 4,102,942 in column 3, lines 1-16. Specific examples of such low molecular weight polyepoxides are 3,4-epoxycyclohexylmethyl 3,4-epoxycyclohexanecarboxylate and bis(3,4-epoxycyclohexylmethyl)adipate. These materials are aliphatic polyepoxides as are the epoxy-containing acrylic polymers. As mentioned above, the epoxy-containing acrylic polymers are preferred because they result in products which have the best combination of coating properties, i.e., smoothness, gloss, durability and solvent resistance. Such polymers have been found to be particularly good in the formulation of clearcoats for color-plus-clear applications.

The polyepoxide is present in the film-forming composition in amounts of about 20 percent by weight to 80 percent by weight and more preferably from 30 percent by weight to 40 percent by weight based on total weight of resin solids.

The composition of the present invention further includes a polyacid curing agent formed from ring opening a polybasic acid anhydride with hydroxyl groups of a polyester prepared by reacting a polybasic acid with an excess of a polyol in which the polybasic acid has a hydrocarbon chain of at least 20 contiguous carbon atoms between the carboxylic acid groups. The polyacid curing agent contains at least two acid groups. The acid functionality is preferably carboxylic acid, although acids such as phosphorus-based acid may be used. Preferably, the polyacid curing agent is a carboxylic acid terminated material having, on average, at least two and preferably greater than two carboxylic acid groups per molecule.

The polyacid curing agents are ester group-containing oligomers that are formed from ring opening a polybasic anhydride with the hydroxyl groups of a polyester prepared from a polybasic acid and a stoichiometric excess of a polyol.

To achieve the desired reaction, the polybasic anhydride and hydroxyl functional polyester are contacted together usually by mixing the two ingredients together in a reaction vessel. Preferably, reaction is conducted in the presence of an inert atmosphere such as nitrogen and in the presence of a solvent to dissolve the solid ingredients and/or to lower the viscosity of the reaction mixture. Examples of suitable solvents are high boiling materials and include, for example, ketones such as methyl amyl ketone, diisobutyl ketone, methyl isobutyl ketone; aromatic hydrocarbons such as toluene and xylene; as well as other organic solvents such as dimethyl formamide and N-methyl-pyrrolidone.

The reaction temperature is preferably low, that is, no greater than 135° C., preferably less than 120° C., and usually within the range of 70°-135° C., preferably 90°-120° C.

The time of reaction can vary somewhat depending principally upon the temperature of reaction. Usually the reaction time will be from as low as 10 minutes to as high as 24 hours.

The equivalent ratio of anhydride to hydroxyl of the hydroxyl functional polyester is preferably at least about 0.8:1 (the anhydride being considered monofunctional) to obtain maximum conversion to the desired half-ester. Ratios less than 0.8:1 can be used but such ratios result in increased formation of lower functionality half-esters.

Among the polybasic anhydrides that can be used in formation of the desired polyesters are those which, exclusive of the carbon atoms and the anhydride moiety, contain from about 2 to 30 carbon atoms. Preferred are 1,2-anhydrides. Examples include aliphatic, including cycloaliphatic, olefinic and cycloolefinic anhydrides and aromatic anhydrides. Substituted aliphatic aromatic anhydrides are also included within the definition of aliphatic and aromatic provided the substituents do not adversely affect the reactivity of the anhydride or the properties of the resultant polyester. Examples of substituents would be chloro, alkyl and alkoxy. Examples of anhydrides include succinic anhydride, methylsuccinic anhydride, dodecenyl succinic anhydride, octadecenylsuccinic anhydride, phthalic anhydride, tetrahydrophthalic anhydride, methyltetrahydrophthalic anhydride, hexahydrophthalic anhydride, alkyl hexahydrophthalic anhydrides such as methylhexahydrophthalic anhydride, tetrachlorophthalic anhydride, endomethylene tetrahydrophthalic anhydride, chlorendic anhydride, itaconic anhydride, citraconic anhydride and maleic anhydride.

The polyacid curing agent typically has an acid value of 30 to 300 mg KOH/g and a number average molecular weight of at least 1000, preferably 2000 to 10,000.

The hydroxyl functional polyesters are formed from reacting an excess of polyol with a polycarboxylic acid having a hydrocarbon chain containing at least 20 contiguous carbon atoms between the carboxylic acid groups.

Among the polyols that may be used to prepare the polyester are diols, triols, tetrols and mixtures thereof. Examples of the polyols are preferably those containing from 2 to 10 carbon atoms such as aliphatic polyols. Specific examples include but are not limited to the following compositions: di-trimethylol propane (bis(2,2-dimethylol)dibutylether); pentaerythritol; 1,2,3,4-butanetetrol; sorbitol; trimethylol propane; trimethylol ethane; 1,2,6-hexanetriol; glycerine; trishydroxyethyl isocyanurate; dimethylol propionic acid; 1,2,4-butanetriol; TMP/epsilon-caprolactone triols; ethylene glycol; 1,2-propanediol; 1,3-propanediol; 1,4-butanediol; 1,5-pentanediol; 1,6-hexanediol; neopentyl glycol; diethylene glycol; dipropylene glycol; 1,4-cyclohexanedimethanol and 2,2,4-trimethylpentane-1,3 diol. Preferably the polyol has a functionality greater than 2 such as trimethylolpropane and pentaerythritol.

Examples of suitable polycarboxylic acids are linear or branched polycarboxylic acid having from 2 to 4 carboxylic acid groups and containing a hydrocarbon chain of at least 20, preferably at least 26, and more preferably from 26 to 40 contiguous carbon atoms between the carboxylic acid groups. Examples of suitable polycarboxylic acids are dimer and polymeric fatty polycarboxylic acids such as those sold under the trademark EMPOL such as EMPOL 1008, EMPOL 1010 available from Cognis, and PRIPOL 1013 available from Uniquema with EMPOL 1008 and PRIPOL 1013 being preferred.

The esterification reaction is carried out in accordance with techniques that are well known to those skilled in the art of polymer chemistry and a detailed discussion is not believed to be necessary. Generally, the reaction can be conducted by combining the ingredients and heating to a temperature of about 160° C. to about 230° C. Further details of the esterification process are disclosed in U.S. Pat. No. 5,468,802 at column 3, lines 4-20 and 39-45.

To introduce hydroxyl functionality into the polyester, a stoichiometric excess of polyol is reacted with the polycarboxylic acid. Typically, the OH/COON equivalent ratio is at least 2 to 1, and may be at least 3 to 1.

The polyacid curing agent is present in the crosslinkable composition in amounts of about 0.5 to 50, preferably 5 to 20 percent by weight based on total weight of resin solids.

The clear coating compositions can be in the form of a one or two component system depending on the reactivity of the polyepoxide material and the polyacid curing agent.

To obtain improved mar and scratch resistance, the clear coating compositions can optionally contain inorganic particles. The inorganic particles can be ceramic materials, metallic materials including metalloid materials. Suitable ceramic materials comprise metal oxides, metal nitrides, metal carbides, metal sulfides, metal silicates, metal borides, metal carbonates, and mixtures of any of the foregoing. Specific, nonlimiting examples of metal nitrides are, for example boron nitride; specific, nonlimiting examples of metal oxides are, for example zinc oxide; nonlimiting examples of suitable metal sulfides are, for example molybdenum disulfide, tantalum disulfide, tungsten disulfide, and zinc sulfide; nonlimiting suitable examples of metal silicates are, for example aluminum silicates and magnesium silicates such as vermiculite.

A preferred inorganic particle is silica including fumed silica, amorphous silica, colloidal silica, alumina, colloidal alumina, titanium dioxide, cesium oxide, yttrium oxide, colloidal yttria, zirconia, colloidal zirconia, and mixtures of any of the foregoing. In another embodiment, the present invention is directed to cured compositions as previously described wherein the particles include colloidal silica. As disclosed above, these materials can be surface treated or untreated.

The coating composition can comprise precursors suitable for forming silica particles in situ by a sol-gel process. The coating composition according to the present invention can comprise alkoxy silanes that can be hydrolyzed to form silica particles in situ. For example tetraethylortho silicate can be hydrolyzed with an acid such as hydrochloric acid and condensed to form silica particles. Other useful particles include surface-modified silicas such as are described in U.S. Pat. No. 5,853,809 at column 6, line 51 to column 8, line 43.

It should be understood that since the cured composition of the invention is employed as a clearcoat in a multi-component composite coating composition, particles should not seriously interfere with the optical properties of the cured composition. As used herein, “transparent” means that the cured coating has a BYK Haze index of less than 50 as measured using a BYK/Haze Gloss instrument.

The inorganic particles when present in the composition are present in amounts of up to 10, preferably 0.05 to 10, more preferably 0.2 to 3 percent by weight based on total weight of the coating composition.

In addition to the foregoing components, the coating compositions of the invention may include one or more optional ingredients such as adjuvant resins including adjuvant curing agents such as aminoplast, plasticizers, anti-oxidants, light stabilizers, mildewcides and fungicides, surfactants and flow control agents or catalysts as are well known in the art. These components when present are present in amounts up to 40 percent by weight based on total weight of the coating composition.

The components present in the curable coating composition of the present invention generally are dissolved or dispersed in an organic solvent. Organic solvents that may be used include, for example, alcohols, ketones, aromatic hydrocarbons, glycol ethers, esters or mixtures thereof. The organic solvent is typically present in amounts of 5 to 80 percent by weight based on total weight of the composition.

The coating compositions of the present invention when deposited on a substrate have good appearance as determined by gloss and distinctness of image, and scratch resistance as measured by gloss retention after abrasive testing, and good humidity resistance. Typical values are shown in the Examples.

### EXAMPLES

The following examples are intended to illustrate the invention, and should not be construed as limiting the invention in any way.

The following examples (A and B) show the preparation of two polyacid curing agents formed from ring opening of a polybasic acid anhydride with the hydroxyl groups of a polyester prepared by reacting a polybasic acid with an excess of a polyol. One of the polyesters was made with a fatty dicarboxylic acid. The second polyester was for comparative purposes and was made with adipic acid.

### Example A

This Example describes the preparation of an acid functional polyester polymer used as a component in the thermosetting compositions of the present invention. The polyester was prepared from the following ingredients as described below.

| Ingredients | Parts by Weight (grams) |
|---|---|
| Empol 1008¹ | 2239.7 |
| Trimethylol propane | 1043.8 |
| Butyl stannoic acid | 5.0 |
| Triphenylphosphite | 5.0 |
| Aromatic hydrocarbon solvent | 1423.4 |
| Hexahydrophthalic anhydride | 2439.9 |
| n-Amyl alcohol | 800.6 |

¹Dimerdiacid available from Cognis.

The polyester polymer was prepared in a four-neck round bottom flask equipped with a thermometer, mechanical stirrer, condenser, dry nitrogen sparge and a heating mantle. The first five ingredients were heated to a temperature of 200° C. and stirred in the flask until about 127 grams of distillate was collected and the acid value dropped below 1.5. The material was then cooled to a temperature of 130° C. and 712 grams of aromatic hydrocarbon solvent was added. Hexahydrophthalic anhydride was then added at 110° C. and the mixture was held at this temperature for 4 hours. The final product was a liquid having a non-volatile content of about 62% (as measured at 110° C. for one hour), and acid value of 102, and weight average molecular weight of 5542 as measured by gel permeation chromatography.

### Example B

### Comparative

This polymer was prepared in the same way as the polymer described in Example A except that Empol 1008 was replaced by adipic acid on equivalent basis. The final product was a liquid having a non-volatile content of about 62% (as measured at 110° C. for one hour), an acid value of 63, and weight average molecular weight of 2253 as measured by gel permeation chromatography.

The following Examples are of various basecoat compositions. Example 1 was an aqueous basecoat.

Examples 2 and 3 were for comparative purposes and were organic solvent borne basecoats as described in U.S. Pat. No. 5,898,052.

### Example 1

The aqueous basecoat was a commercial product available from PPG Industries as HWT 36427. The basecoat composition was formulated with a polyester polyol, an acrylic polyol and aminoplast curing agent.

### Examples 2 and 3

### Comparative

The solvent borne basecoats were taken from U.S. Pat. No. 5,898,052, Example 1 of Table 2 and Example 3 of Table 2. The formulations for the basecoat were as follows:

### Example 2

### (Comparative) (U.S. Pat. No. 5,898,052, Example 1, Table 2)

| | Solid Weight | Weight |
|---|---|---|
| Ingredient | (grams) | (grams) |
| Patent Component (A-i) GMA acrylic | 39.90 | 57.00 |
| Patent Component (B-ii) Acid/OH | 30.10 | 43.00 |
| crosslinker | | |
| Patent Component (c-i) Cymel 202 | 30.40 | 38.00 |
| Alpate 7670NS¹ | 9.98 | 15.01 |
| Methyl Isobutyl Ketone | — | 109.80 |
| Total | 110.38 | 262.81 |

¹Aluminum paste available from Toyal Europe.

### Example 3

### (Comparative) (U.S. Pat. No. 5,898,052 Example 3, Table 2)

| | Solid Weight | Weight |
|---|---|---|
| Ingredient | (grams) | (grams) |
| Patent Component (A-i) GMA acrylic | 39.90 | 57.00 |
| Patent Component (B-ii) Acid/OH | 30.10 | 43.00 |
| crosslinker | | |
| Patent Component (c-ii) Cymel 370¹ | 29.92 | 34.00 |
| Alpate 7670NS | 9.98 | 15.01 |
| Methyl Isobutyl Ketone | — | 119.05 |
| Total | 109.90 | 268.06 |

¹Melamine formaldehyde resin available from CYTEC Industries, Inc.

The following Examples are of transparent topcoat compositions based on polyepoxide-polyacid curing agents. Example 4 uses as the polyacid curing agent of Example A and Example 5 uses the polyacid curing agent of Example B.

### Example 4

The transparent topcoat composition was prepared from the following ingredients:

| | Solid Weight | Weight |
|---|---|---|
| Ingredient | (grams) | (grams) |
| PACK 1 | | |
| Dowanol DPM ®¹ | — | 5.84 |
| n-Pentyl Propionate | — | 11.00 |
| Tinuvin 328² | 2.54 | 2.54 |
| Treated Colloidal Silica³ | 0.50 | 3.47 |
| Acrylic Polymer⁴ | 38.69 | 60.45 |
| ERL-4221⁵ | 6.00 | 6.00 |
| Cymel 202⁶ | 5.00 | 6.25 |
| Q-293⁷ | 0.37 | 0.37 |
| Byk 331⁸ | 0.03 | 0.03 |
| 50% solution of Dynoadd F-1⁹ | 0.16 | 0.33 |
| PACK 2 | | |
| n-Pentyl Propionate | — | 8.38 |
| Isobutyl Acetate | — | 6.64 |
| Fumed Silica Dispersion¹⁰ | 3.79 | 10.11 |
| Acid Crosslinker¹¹ | 29.42 | 40.58 |
| Acid Crosslinker of Example A | 18.00 | 28.59 |
| ADMA 12 Catalyst¹² | 1.99 | 1.99 |
| TOTAL | 106.49 | 192.57 |

¹Solvent available from Dow Chemical Co.
²UV absorber available from Ciba Additives.
³“Silica B” prepared as described in U.S. Patent Ser. No. 11/145,812, filed Jun. 6, 2005, incorporated by reference herein.
⁴A polymer consisting of 60% glycidyl methacrylate, 30.8% n-butyl methacrylate, 0.2% methyl methacrylate, 7% styrene, and 2% alpha methyl styrene dimer. The Mw of the polymer is about 2500 having an epoxy equivalent weight on solids of 237. The polymer is 64% solids in n-pentyl propionate.
⁵Cycloaliphatic diepoxide available from Dow Chemical Co.
⁶Melamine formaldehyde resin available from CYTEC Industries, Inc.
⁷Light stabilizer available from New York Fine Chemicals.
⁸Polyether/dimethylpolysiloxane copolymer available from Byk Chemie.
⁹A silicone-free polymer available from Dyno Cytec that was diluted to a 50% solution in a 1/1 blend of n-butyl acetate and Butyl Cellosolve ® Acetate available from Dow Chemical Co.
¹⁰HDK ® H30LM fumed silica available from Wacker Chemie AG dispersed in a polymer consisting of 55% 4-methylhexahydrophthalic anhydride, 23% hexahydrophthalic anhydride, and 22% trimethylol propane in n-butyl acetate at 72.5% solids about 650 Mw and acid equivalent weight on solids of 205.
¹¹A polymer consisting of 55% 4-methylhexahydrophthalic anhydride, 23% hexahydrophthalic anhydride, and 22% trimethylol propane in n-butyl acetate at 72.5% solids about 650 Mw and acid equivalent weight on solids of 205.
¹²Amine available from Albemarle Corp.

### Example 5

### Comparative

The transparent topcoat composition was prepared from the following ingredients:

| | Solid Weight | Weight |
|---|---|---|
| Ingredient | (grams) | (grams) |
| PACK 1 | | |
| Dowanol DPM ® | — | 5.84 |
| n-Pentyl Propionate | — | 11.00 |
| Tinuvin 328 | 2.54 | 2.54 |
| Treated Colloidal Silica | 0.50 | 3.47 |
| Acrylic Polymer of Ex 4 | 39.94 | 62.41 |
| ERL-4221 | 6.00 | 6.00 |
| Cymel 202 | 5.00 | 6.25 |
| Q-293 | 0.37 | 0.37 |
| Byk 331 | 0.03 | 0.03 |
| 50% solution of Dynoadd F-1 | 0.16 | 0.33 |
| PACK 2 | | |
| n-Pentyl Propionate | — | 8.38 |
| Isobutyl Acetate | — | 6.64 |
| Fumed Silica Dispersion | 3.79 | 10.11 |
| Acid Crosslinker of Ex 4 | 33.13 | 45.70 |
| Acid Crosslinker of Example B | 13.04 | 21.03 |
| ADMA 12 Catalyst | 1.99 | 1.99 |
| TOTAL | 106.49 | 192.09 |

The following Examples are of color-clear composite coatings using an aqueous pigmented basecoat and transparent topcoat compositions of Examples 4 and 5.

The clear film forming compositions of Examples 4 and 5 were spray applied to aqueous pigmented basecoats as indicated in the tables below to form color-plus-clear composite coatings over primed electrocoated steel panels. The panels were ACT cold roll steel panels (10.16 cm by 30.48 cm) with ED6060 electrocoat available from ACT Laboratories, Inc. The panels were coated with either HWB9517, a black pigmented waterborne basecoat available from PPG Industries or HWT36427, a silver pigmented waterborne basecoat available from PPG Industries. Basecoats were automated spray applied to the electrocoated steel panels at ambient temperature (about 70° F. (21° C.)). A dry film thickness of about 0.5 to 0.7 mils (about 12 to 17 micrometers) was targeted for the basecoat. The basecoat panels were dehydrated for 5 minutes at 176° F. (80° C.) prior to clearcoat application.

The basecoat compositions (Examples 1-3) were automated spray applied to primed electrocoated steel panels at ambient temperature (about 70° F. (21° C.)). The panels used were ACT cold roll steel panels (10.16 cm by 30.48 cm) with ED6060 electrocoat available from ACT Laboratories, Inc. A dry film thickness of about 0.6 to 0.8 mils (about 16 to 19 micrometers) was targeted for the basecoat. The basecoat panels were dehydrated for 5 minutes at 176° F. (80° C.) prior to clearcoat application.

The clear coating composition of Example 4 was automated spray applied to the basecoated panels at ambient temperature in two coats with an ambient flash between applications. The clearcoat was targeted for a 1.7 mils (about 43 micrometers) dry film thickness. The coatings were allowed to air flash at ambient temperature before the oven. Panels were baked for thirty minutes at 260° F. (127° C.) to fully cure the coating(s). The panels were tested for appearance properties (such as 20° Gloss, DOI, Color, and Flop Index). The results are reported below.

TABLE 1
Appearance Properties

| Example | | | |
|---|---|---|---|
| Basecoat/Clearcoat | Flop Index¹ | 20° Gloss² | DOI³ |
| 1/4 | 13.89 | 91 | 93 |
| 2/4 | 7.56 | 86 | 83 |
| 3/4 | 7.66 | 86 | 83 |

¹Measurement corresponding to a ratio of specular versus angular reflectance obtained from an X-Rite MA68II multi-angle spectrophotometer. The higher the number, the better the flop.
²The 20° gloss was measured with a NOVO-GLOSS statistical glossmeter available from Gardco.
³The DOI (Distinctness of Image) was measured with a DOI/HAZE meter Model 807A available from Tricor Systems, Inc.

The data reported in Table I above shows that the composite basecoat/clearcoat coating of the present invention in which the clearcoat is based on a polyepoxide-polyacid curing agent and is applied over a water borne endcoat has superior appearance to comparative composite coatings in which the clearcoat is applied over a solvent borne basecoat.

The following Examples are of color clear composite coatings in which the transparent topcoat compositions of Examples 4 and 5 were applied over an aqueous pigmented basecoat.

The clear coating compositions of Examples 4 and 5 were each automated spray applied to a basecoated panel at ambient temperature in two coats with an ambient flash between applications. Clearcoats were targeted for a 1.7 mils (about 43 micrometers) dry film thickness. All coatings were allowed to air flash at ambient temperature before curing. Panels were baked for thirty minutes at 260° F. (127° C.) to fully cure the coating(s). The panels were tested for properties such as Mar Resistance (Amtec car wash and Atlas Crockmeter) and Humidity Resistance (140° F. (60° C.) and 110° F. (43° C.) QCT Condensation Tester and 100° F. (38° C.) Humidity Cabinet). Properties for the coatings are reported in the tables below.

TABLE 2
Scratch Resistance

| | | | | Car Wash² | | | |
|---|---|---|---|---|---|---|---|
| | | | Crockmeter¹ | (Mar 20° Gloss) | | | |
| | | Initial 20° | (Mar 20° Gloss) | Cycles | | | |
| Clearcoat | Basecoat | Gloss | 10 Cycles | 10 | 20 | 30 | 40 |
| Example 4 | HWB9517 | 85 | 51 | 51 | 23 | 10 | 5 |
| | Black | | | | | | |
| Example 5 | HWB9517 | 85 | 60 | 42 | 17 | 7 | 4 |
| | Black | | | | | | |

¹The Crockmeter test used the following procedure:
1. The acrylic finger of an Atlas AATCC Crockmeter, model CM-5 manufactured by Atlas Electric Devices Company, Chicago, Ill., was covered with a two inch by two inch (3 cm by 3 cm) piece of felt cloth, obtainable from Atlas Electric Devices and a two inch by two inch (3 cm by 3 cm) piece of nine (9) micron polishing paper available from the 3 M Company.
2. The cleanser coated panel was rubbed 10 times (10 double rubs) using the Crockmeter.
3. The test was repeated at least once changing the felt cloth and polishing paper after each test.
4. The 20° gloss was measured using the Novo-Gloss gloss meter mentioned above on both the unmarred part of the panel and the marred parts of the panel. The difference in gloss was a measure of the mar resistance. The smaller the difference, the greater the mar resistance.
²The Car Wash Test was determined by using an Amtec Car Wash Machine. The test method used consists of an Amtec Car Wash Lab Apparatus for Test Sheets and a washing suspension of 30 grams of Sikron SH200 grit per 20 liters of tap water as described in DIN 55668. The 20° gloss readings were made using a Novo-Gloss ™ Statistical Glossmeter by Gardco ®. Amtec Car Wash Lab Apparatus for Test Sheets and Sikron SH200 are available from Amtec Kistler GmbH.

The test data in Table 2 shows that the composite coatings of the present invention have improved scratch resistance when determined by the car wash test in relation to the comparative example.

TABLE 3
Humidity Resistance

| | | | | 10 Day |
|---|---|---|---|---|
| | | | | 100° F./ |
| | | 4 Day 140° F. | 4 Day 110° F. | 100% RH |
| Clearcoat | Basecoat | QCT | QCT | Cabinet |
| Example 4 | HWT36427 | 8 Few | 10 No | 10 No |
| | Silver | Slight Blush | Blush | Blush |
| Example 5 | HWT36427 | 8 Dense | 10 No | 10 No |
| | Silver | Slight Blush | Blush | Blush |
| Example 4 | HWB9517 | 10 No | 10 No | 10 No |
| | Black | Blush | Blush | Blush |
| Example 5 | HWB9517 | 10 No | 10 No | 10 No |
| | Black | Blush | Blush | Blush |

Rating for blistering uses ASTM D714-87. No. 10 represents no blistering. No 8 represents smallest blisters easily seen by the unaided eye. Frequency of blistering is represented by Dense, Medium Dense, Medium, and Few. Rating for blush is a visual observation.

The test data reported in Table 3 shows the composite coatings of the invention and the comparative example have good humidity resistance, with the composite coatings of the invention having better humidity resistance determined by the 4-day 140° F. test.

Whereas particular embodiments of this invention have been described above for purposes of illustration, it will be evident to those skilled in the art that numerous variations of the details of the present invention may be made without departing from the invention as defined in the appended claims.

1. A multi-component composite coating composition comprising a pigmented film-forming composition serving as a basecoat and a clear film-forming composition serving as a transparent topcoat over the basecoat wherein
(a) the basecoat is deposited from an aqueous-based pigmented film-forming composition, and
(b) the transparent topcoat is deposited from a film-forming composition comprising:
(i) a polyepoxide, and
(ii) a polyacid curing agent formed by ring opening of a polybasic acid anhydride with hydroxyl groups of a polyester prepared by reacting a polybasic acid with an excess of a polyol in which the polybasic acid has a hydrocarbon chain containing at least 20 contiguous carbon atoms between the carboxylic acid groups.

2. The composition of claim 1 in which the aqueous-based pigmented film-forming composition comprises:
(a) a polymer with reactive functional groups, and
(b) a curing agent with functional groups reactive with the functional groups of (a).

3. The composition of claim 2 in which the functional groups of (a) are selected from hydroxyl and carboxylic acid.

4. The composition of claim 2 in which the curing agent is an aminoplast.

5. The composition of claim 1 in which the polyepoxide is a copolymer of glycidyl acrylate or glycidyl methacrylate with at least one other copolymerizable monomer.

6. The composition of claim 5 in which the other copolymerizable monomer comprises an alkyl ester of acrylic or methacrylic acid.

7. The composition of claim 1 in which the polyepoxide has a number average molecular weight of from 500 to 20,000 and an epoxy equivalent weight on a resin solids basis of 150 to 1500.

8. The composition of claim 1 in which the polybasic acid has a hydrocarbon chain containing at least 26 contiguous carbon atoms between the carboxylic acid groups.

9. The composition of claim 1 in which the polybasic acid is a fatty dicarboxylic acid.

10. The composition of claim 9 in which the fatty dicarboxylic acid has a hydrocarbon chain of from 26 to 40 contiguous carbon atoms between the carboxylic acid groups.

11. The composition of claim 1 in which the polyol has a functionality greater than 2.

12. The composition of claim 11 in which the polyol is selected from trimethylolpropane and pentaerythritol.

13. The composition of claim 1 in which the curing agent has an acid value of 30 to 300 mg KOH/g.

14. The composition of claim 1 in which the curing agent has a number average molecular weight of at least 1000.

15. The composition of claim 1 in which
(i) is present in the film-forming composition of (b) in amounts of 20 to 80 percent by weight and
(ii) is present in amounts of 0.5 to 50 percent by weight;
the percentages by weight being based on total weight of resin solids.

16. A multi-component composite coating composition comprising a pigmented film-forming composition serving as a basecoat and a clear film-forming composition serving as a transparent topcoat over the basecoat, wherein
(a) the basecoat is deposited from an aqueous-based pigmented film-forming composition, and
(b) the transparent topcoat is deposited from a film-forming composition comprising:
(i) a polyepoxide, and
(ii) a polyacid curing agent formed by ring opening of a polybasic acid anhydride to the hydroxyl groups of a polyester prepared by reacting a fatty dicarboxylic acid with an excess of a polyol having a functionality greater than 2.

17. The composition of claim 16 in which the fatty dicarboxylic acid has a hydrocarbon chain of from 26 to 40 contiguous carbon atoms between the carboxylic acid groups.

18. The composition of claim 16 in which the polyol is selected from trimethylolpropane and pentaerythritol.

19. The composition of claim 16 in which the curing agent has an acid value of 30 to 300 mg KOH/g.

20. The composition of claim 16 in which the curing agent has a number average molecular weight within the range of 2000 to 10,000.

21. The composition of claim 16 in which
(i) is present in the film-forming composition of (b) in amounts of 30 to 40 percent by weight, and
(ii) is present in amounts of 5 to 20 percent by weight;
the percentages by weight being based on total weight of resin solids in (b).

22. The composition of claim 1, wherein the film-forming composition of the transparent topcoat further comprises a melamine formaldehyde resin.

23. The composition of claim 1, wherein the aqueous-based pigmented film-forming composition of the basecoat comprises: a polymeric component and a curing agent component, wherein the polymeric component comprises one or more polymers with reactive functional groups; and wherein the curing agent component comprises a curing agent with functional groups reactive with the functional groups of the polymer, and wherein when the curing agent comprises an aminoplast, the polymeric component consists essentially of one or more polymers having reactive functional groups consisting of hydroxyl.
